(19) United States
(12) Patent Application Publication
(10) Pub. No.: US 2009/0278941 A1
(43) Pub. Date: Nov. 12, 2009

(54) MULTI-CHANNEL STREAMING DEVICE AND RELATED METHOD

(76) Inventors: Mark Hilton Smith, Santa Monica, CA (US); William Luke Snitzer, Los Angeles, CA (US)

Correspondence Address: GRAYBEAL JACKSON LLP, 155 - 108TH AVENUE NE, SUITE 350, BELLEVUE, WA, 98004-5973, US

(21) Appl. No.: 12/463,396

(22) Filed: May 9, 2009

Related U.S. Application Data
(60) Provisional application No. 61/052,199, filed on May 10, 2008.

(51) Int. Cl. H04N 5/225; H04N 7/173

(52) U.S. Cl. 348/207.1; 725/112; 725/131; 348/E05.024

(57) ABSTRACT

A multi-channel streaming device for transmitting audio/video signals or any data from a remote location to a server computer. The device may include an input for receiving a signal, a distribution module coupled to the input and operable to divide the signal into a plurality of packets and operable to distribute the packets and a plurality of transmission channels coupled to the distributor such that the distributor distributes packets amongst the plurality of channels, each channel having a bandwidth wherein the distribution module is operable to change the distribution to a channel based on the bandwidth. Such real-time analysis of each communication channel offers an advantage of customizing the use of each channel according to its ability to deliver signals.

### PRIORITY CLAIM

This application claims priority to U.S. Provisional Patent application No. 61/052,199 filed on May 10, 2008 and entitled “______” and is hereby incorporated by reference.

### BACKGROUND

Television broadcasting has been prevalent for many years such that recorded or live feeds of audio and video signals may be delivered to millions of destinations relatively simultaneously. With the advancement of remote technologies, broadcasting companies and other related companies have the ability to record events at remote locations (i.e., not in a production studio) and then transmit the audio and video signals to a production studio. At the production studio, remote audio and video signal feeds could be edited, combined and simply fed directly to a distribution system for general consumption.

Remote uploading of audio and video signals typically involves relatively large equipment that is often housed and transported in a vehicle (e.g., a remote truck). In one conventional manner, a camera crew may record events with a video camera (which also captures an audio signal). Such cameras may be coupled via a signal cable to the equipment in the remote truck where an operator may locally process the captured audio and video signals or may simply transmit the raw footage to a production studio.

Transmission of these captured audio and video signals often involves expensive dedicated systems. In one conventional example, a satellite linkup system may transmit the audio/video feed to a satellite orbiting the earth such that the satellite retransmits the A/V feed back to a production studio. In a different conventional example, a microwave system may be utilized wherein signals are transmitted and received via a series of wirelessly interconnected microwave towers. In either of these example systems and in other conventional examples, the transmission of remotely collected audio and video signals involves expensive and dedicated systems that typically require an entire remote truck to transport to the various remote locations. This is bulky, inefficient and not cost-effective.

### BRIEF DESCRIPTION OF THE DRAWINGS

The foregoing aspects and many of the attendant advantages of the claims will become more readily appreciated as the same become better understood by reference to the following detailed description, when taken in conjunction with the accompanying drawings, wherein:

FIG. 1 is a diagram of a system that may use a multi-channel streaming device for transmitting audio/video signals to a remote server computer according to an embodiment of the subject matter disclosed herein.

FIG. 2 is a block diagram of an input channel of an MCS device configured according to an embodiment of the subject matter described herein.

FIG. 3 is a block diagram of a distribution module of an MCS device configured according to an embodiment of the subject matter described herein.

FIG. 4 is a block diagram of a receiving system configured to receive AV data transmitted from the MCS device of FIGS. 2 and 3.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

By way of overview, the subject matter disclosed herein may be a system and method for transmitting remotely collected audio and video signals to another location via a multi-channel wireless network. A camera or other similar audio/video (AV) device may capture images and sounds such that signals are generated that represent the images and sounds captured. Then the camera may feed the generated signals to a remote wireless transmission unit for transmission to a network that is also coupled to a server computer. The remote wireless transmission unit may include a plurality of devices that are capable of communicating with a local wireless network. The AV signals captured and generated by the camera may then be multiplexed across the plurality of local wireless networks. The server computer may receive the AV signals from each of the wireless networks and reassemble the multiplexed signals resulting in a complete AV signal feed without the need for bulky and more expensive satellite or microwave technologies. These and other advantages are discussed below with respect to the figures.

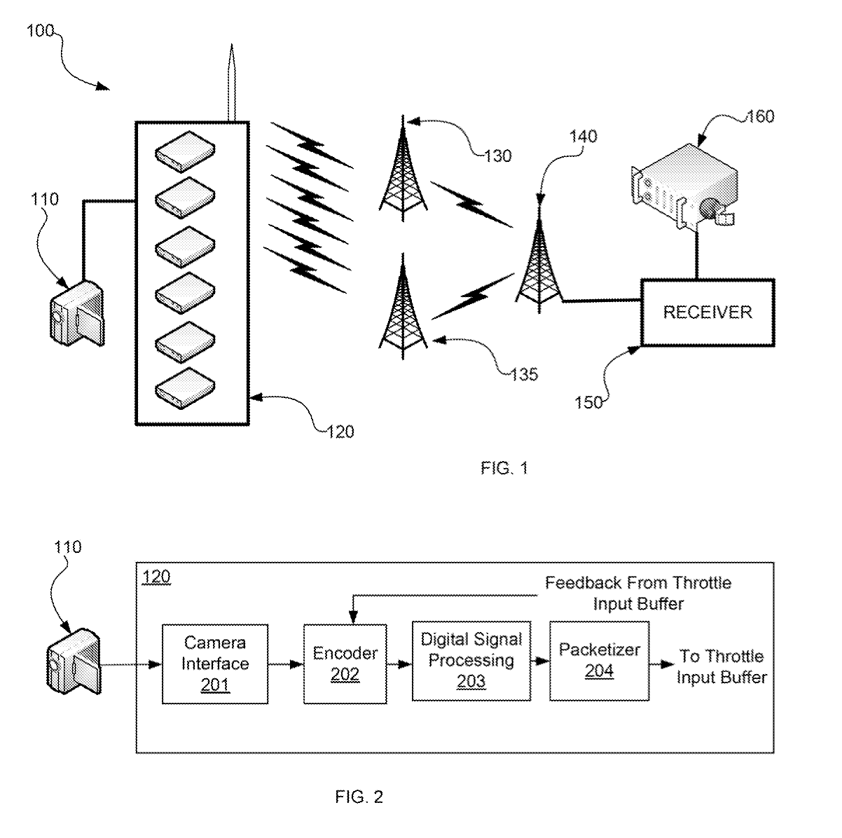

FIG. 1 is a diagram of a system 100 that may use a multi-channel streaming device 120 for transmitting audio/video signals to a remote server computer according to an embodiment of the subject matter disclosed herein. This system 100 is an exemplary system and the description in the next paragraphs are intended as an overview of one system that may be suited for utilizing the capabilities of a multi-channel streaming device. Other systems are contemplated but not described in detail herein for brevity.

A videographer or other remote camera operator may use a camera 110 in the field for capturing images and sounds as AV data. Such a camera 110 may be, as is known in the art, a professional video camera capable of capturing motion picture data in high definition and capturing audio data with many channels. Alternatively, the camera 110 may be any other commonly available video-capture device such as DV camera, a camcorder, or any other conventional video camera.

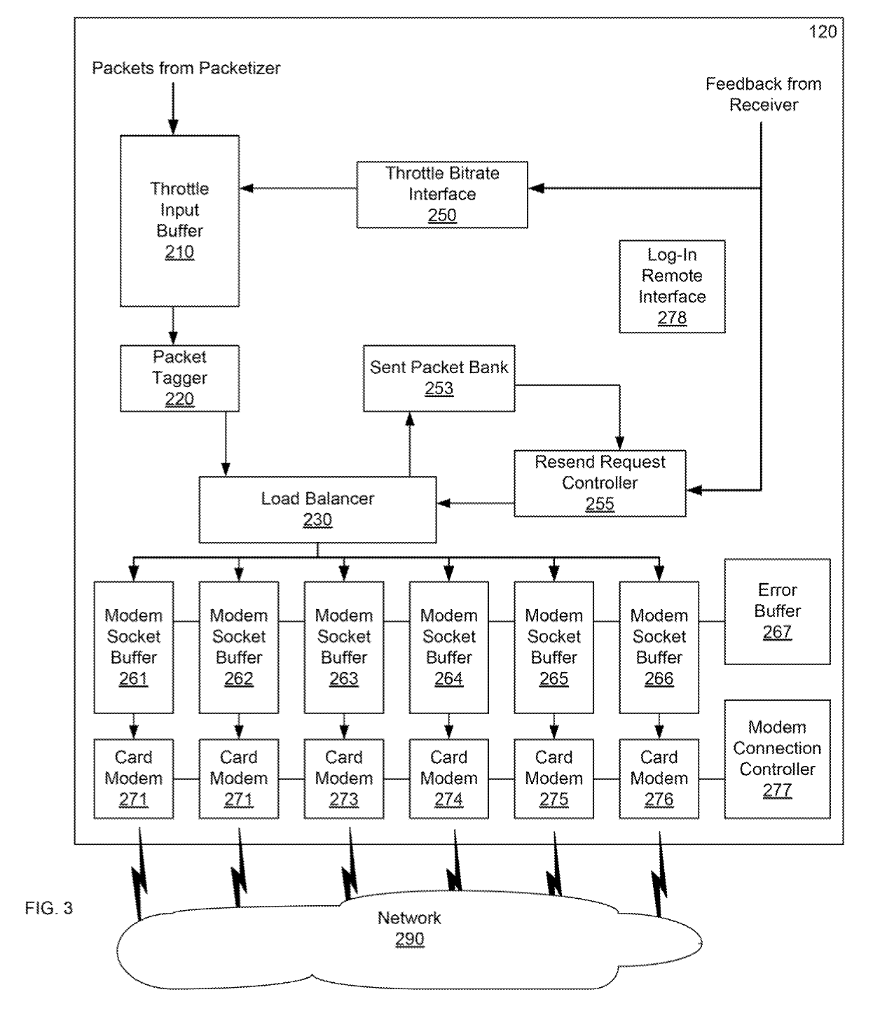

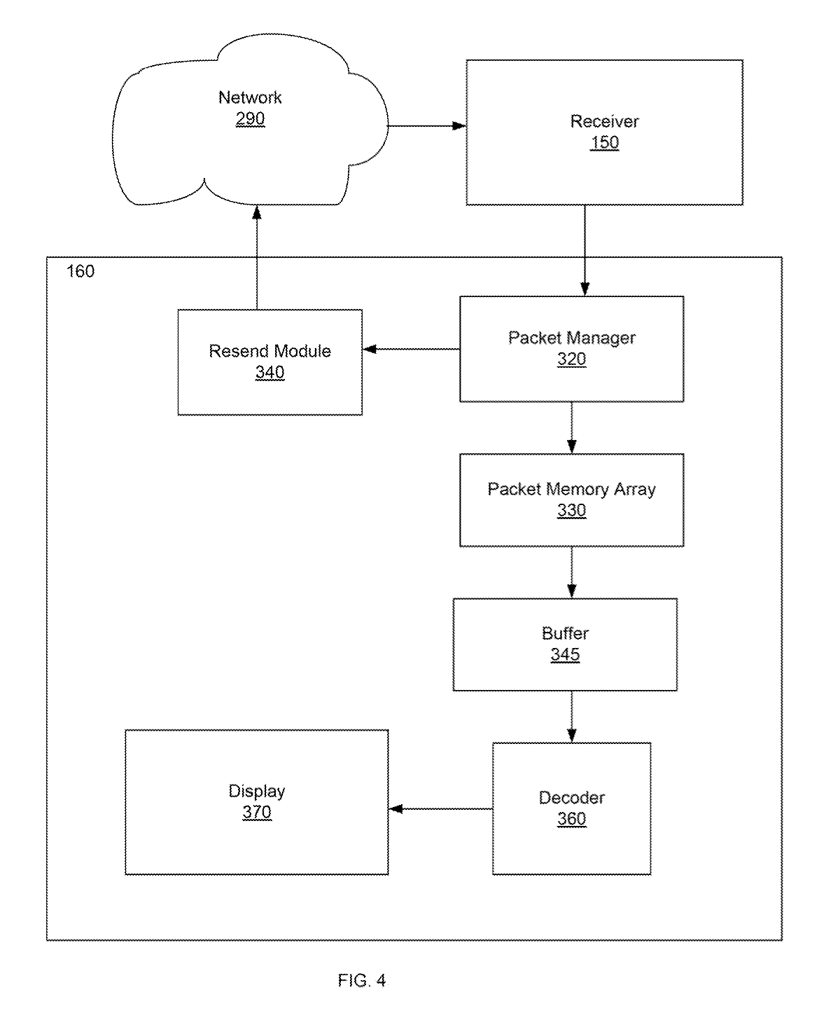

The camera may be coupled to a multi-channel streaming device 120 that receives AV signals from the camera 110 via a conventional signal cable, such as a USB or IEEE 1394 Firewire connection. As will be described below with respect to FIGS. 2 and 3, the MCS device 120 processes the AV signals and then generates digitized packets of data representing the original AV signal stream. The MCS device 120 may include a plurality of wireless communication channel interfaces operable to transmit the digitized packets to one or more wireless network communication towers 130, 135 and 140. These wireless communication towers 130, 135, and 140, may also communicate with each other in order to transmit any signal to its intended destination. In this case, the digitized packets may be received at a receiver 150 whose operations are described below with respect to FIG. 4. The receiver 150 may then pass the received digitized packets to a server computer 160 that is configured to reassemble the digitized packets in order to arrive at the original AV signals as generated at the camera 110.

FIG. 2 is a block diagram of an input channel of an MCS device 120 configured according to an embodiment of the subject matter described herein. As described above, the video camera 110 may be coupled to the MCS device via a conventional signal cable. The communication cable may then be coupled to a camera interface 201 suited to receive the AV signals from the camera 110 in a format matched to the camera 110 and the cable (i.e., USB or IEEE 1394 Firewire connection,

The camera interface 201 may be coupled to an encoder that may be configured to encode the AV signal received from the camera 110. The encoder 202 may be an H264 video encoder that is configured to adjust its encoding according to feedback about based on information from a throttle input buffer (element 210 of FIG. 3 as described in detail below). Other formats for encoding may also be utilized including MPEG-4, MPEG-3, etc. Additionally, a number of source signals may be encoded including serial digital interface (SDI), high-definition SDI, video composite, video component, or any digital signal of any nature containing media or data. Once the AV signals are encoded, the signals may then be digitally processed locally at the MCS device 120 before transmission via the aforementioned wireless communication networks. Examples of common digital signal processing include digital image processing, video compression, and digitized packetization. After the AV signals are conditioned according to the desired DSP chain, the AV signals may parsed by a packetizer 204 into a series of digitized packets suitable for transmission on a packet-switched network, such as the Internet or a wireless network. The packetizer 204, generates packets of incoming AV data into transmittable sized packets and appends these packets with a 16-bit sequence number. This sequence number enables the resending of lost packets and re-sequencing of out of order packets as described further below. The digitized packets, once created, are then sent to the throttle input buffer 210 as shown in FIG. 3.

FIG. 3 is a block diagram of a distribution module of an MCS device 120 configured according to an embodiment of the subject matter described herein. The throttle input buffer 210 may be a buffer memory suited to receive the digitized packet of AV data. As with any typical buffer, the packets may be stored in a First-In First-Out (FIFO) memory protocol until packets are ready to be transmitted on one of a plurality of wireless networks. Thus, as packets are received, the packets may be stored in this buffer until a specific channel is ready or may be sent directly to a channel as it may be immediately ready for packet transmission.

Next, the digitized packets may be sent to a packet tagger 220. The packet tagger 220 may assign a number to each digitized packet in order to keep track of packet ordering and to help identify any packet loss that may occur. After each packet is tagged, it may be sent to a distribution module referred to as a load balancer 230. The load balancer 230 may analyze the available communication channels and then distribute the outgoing packets across the available network interfaces according to a pre-determined algorithm. Each available communication channels may correspond with a respective modem socket buffer 261-266 and a respective modem card 271-276. In the embodiment shown in FIG. 3, there are six such communication channels. However, more or fewer channels may be present in an MCS device 120

Additionally, each communication channel may be part of a mounting structure referred to as a deck. Such a deck may be used to hold each modem card 271-276 in a specific position in a specific array. In one embodiment, the deck holds six modem cards on three panels. Each panel may hold two modem cards in a vertical manner and each panel may then be arranged as part of a triangular structure wherein the back of each card modem panel form a triangular cavity between the three panels. The three modem cards in each level (i.e., top-most modem card for each of the three panels) arranged in a triangle helps facilitate a clear wireless communication path and helps prevent out-of-phase bouncing and shadowing. The entire deck may then be coupled to a cylindrical housing resembling an antennae as well as be coupled a cooling mechanism for maintaining a suitable operating temperature. Such a cylindrical deck may then be mounted to a car roof or extended from a backpack to maximize communication channel connectivity.

Each communication channel may be coupled to any available communication network including a cellular telephone network, a Wi-Fi network, a WiMax network, or Ethernet. These communication networks are collectively shown as the network 290 in FIG. 3. Furthermore, each channel may be from the same service provider or may each be configured to access different service provider networks. In one embodiment, the first two channels correspond to a first service provider, the next two channels correspond to a second service provider and the final two channels correspond to a third service provider. In this manner, if the MCS device 120 (which is portable) is moved out of communicative contact with a network from a first provider, there remains two more service providers and four channels in which AV data may be transmitted.

The algorithm in which the load balancer 230 follows for distributing packets to the communications channels may be an equally balanced algorithm wherein an equal number of packets are distributed across each of the six channels. Other algorithms may be used as well. For example, if one service provider is known to have a slower network, the other channels may be more heavily weighted for receiving packets. As another example, an assessment of the strength of signal for a particular network may also be used to adjust the amount of packets sent to corresponding modem socket buffers for said channels. With any distribution algorithm, the load balancer 230 sends a plurality of packets to each modem socket buffer 261-266 and keeps each modem socket buffer 261-266 filled to ensure the maximum performance of each channel. Thus, as packets are transmitted over a respective network, the load balancer refills each modem socket buffer 261-266 accordingly.

The load balancer 230 may be coupled to a modem connection controller 277 which is, in turn, coupled to each modem card 271-276 for each channel. The modem connection controller 277 may send modem connection status for each modem card 271-276 to the load balancer 230. If a network connection fails, then the modem connection controller 277 indicates to the load balancer 230 to utilize other network connections. If a new network connection becomes available again then the modem connection controller 277 indicates to the load balancer 230 to include or utilize the new or restored connection. The modem connection controller 277 allows for real time change in the network configuration without any interruption in the data transmission and video stream. The modem connection controller 277 may also be controlled remotely by a user via a log-in remote interface 278.

Sometimes, packets may be lost or corrupted after being transmitted out from the MCS device 120. Thus, at the receiver side (described below with respect to FIG. 4), the server computer (element 160 of FIG. 1) may identify missing or corrupted packets as it is reassembling the media stream. The missing or corrupted data packets are then requested via a feedback channel wherein each missing or corrupted packets may be requested to be resent.

Thus, as the load balancer 230 distributes the packets across the available channels, a duplicate (local copy) packet is sent to a sent packet bank 253 where a log is stored in a memory of all packets. Based on feedback information from the server computer at the receiving location, a resend request controller 255, may pull the specific requested missing or corrupted packet from the sent packet bank and prioritize it to the front of the queue in the load balancer 230. This insures timely retransmission of the lost or corrupted packets. Furthermore, another embodiment may have redundancy for resending packets wherein a packet requested to be resent may be loaded into each modem socket buffer 261-266. In this manner, the requested packet will necessarily be sent via the first available channel. Once the first packet to reach transmission is accomplished, the remaining resend packets are ignored or discarded.

An error buffer 267 may be coupled to each modem socket buffer 261-266 and may be configured to monitor the status of each modem socket buffer to the load balancer 230. Thus, the error buffer 267 can determine if a packet was successfully cued to be sent via one of the channels. If any packet was not successfully cued, the error buffer 267 returns an error message to the load balancer 230 enabling the load balancer 230 to try a different channel or modem socket buffer 261-266. In locations with limited network connectivity, the load balancer 230 may not be able to send packets to any modem socket buffer 261-266. In this case, the load balancer 230 will not be able to input new packets due to degraded network connectivity.

The error buffer 267 may also generate throttling information that may be used to increase or decrease rate at which the throttle input buffer 210 passes packets to the load balancer 230. Thus, by analyzing the performance of each modem socket buffer 261-266, the error buffer 267 may initiate control via a throttling bit rate interface 250. The throttling bit rate interface 250 may then control the throttle input buffer 210 to adjust that rate at which the encoder provides packets. In one embodiment, the throttle bit rate interface 250 may use an algorithm that bases the rate at which packets are provided on the total throughput of the modem socket buffers 261-266. Thus, the throttle input buffer 210 may calculate the required input rate to keep the buffer size to a minimum while maximizing the input rate.

In one embodiment, identical packets may be sent to a different wireless network or other provider network card at the same time. For example, if three different phone company network modem cards were utilized (for example, two AT&T™ modem cards, two Sprint™ modem cards and two Verizon™ modem cards) out of the six or more available, in the below mentioned array, then the same packet would be sent at the same time to three different phone company networks modem cards. In this configuration, the load balancer 230 may send the same packet to three modem socket buffers 261, 263, and 265; these three modem socket buffers would be linked to three different network cards (e.g., AT&T™, Sprint™ and Verizon™) 271, 273, and 275. This would triple the probability of a packet getting to the receiver without getting lost. The first packet to arrive would be utilized and duplicate packets would be ignored. This method would eliminate of any latency due to packets getting lost and necessitating resends in addition, it reduces latency due to network delays and transmission irregularities. The above feature could be utilized with Wi-Fi, Wimax or any available network connection.

The MCS device 120 may also include a log-in remote interface 278 that enables a remote operator to control some functions of the MCS device 120. This enables the MCS device 120 to be optimized for different geographic locations, debugged and updated with new software at any time.

FIG. 4 is a block diagram of a receiving system configured to receive AV data transmitted from the MCS device 120 of FIGS. 2 and 3. As discussed above, the MCS device 120 may transmit packet of AV data across a number of communication channels corresponding to a respective communication network (i.e., a cellular network, etc.) which are collectively referred to as the network 290. Each channel utilized may be communicatively coupled to a receiver 150. The receiver, may provides digital signal processing directed to error-code correction and improvement of packet communication unrelated to the underlying data in each packet. Once packets are received at the receiver, they are passed to a packet manager 320 that may be part of a server computer 160.

The packet manager 320 receives all packets from the network and sorts the packets into an ordered sequence by interpreting the sequence numbers appended to the packets during encoding. Once sorted, the packets may be stored in a packet memory array 330 that may be used as a temporary storage for organizing all incoming packets before broadcast to the client, internet or broadcast TV. Furthermore, the packet memory array may determine which packets may have not been transmitted correctly such as missing or corrupted packets. Upon assembly of a requisite number of packets in the packet memory array 330, missing or corrupted packets may need to be re-acquired. Thus, a resend request may be initiated via a resend module 340 which identifies missing packets in the packet memory array 330 and makes a resend packet request simultaneously via all available network connections to the resend request controller 255 (FIG. 3).

As data packets are received, actual AV signals may then be generated based upon a reassembling of the data packets. A buffer is coupled to the packet memory array 330 such that packets may be stored (in a FIFO manner) before being passed to a decoder 345 for reassembly. The decoder 345 may also append time code to the AV signals. Then, the reassembled AV signals may be passed to a display which may render the audio and video signals. In a studio setting, these signals may be passed to many other components for broadcast, rebroadcast, editing, recording, etc.

The above-described system may employ a number of additional features via various components that enhance the functionality of the MCS device and related systems. In one additional feature, a global positioning system (GPS) locator may provide location information on a customized moving map. In another feature, a geographic network compensator may identify the available throughput of all communication networks with which the MCS device 120 may interface. Along with the GPS data, the MCS device 120 may favor data upload to the best available communication networks.

Yet another feature of the system is a time warp feature which has the ability to accelerate the rate at which AV signals are rendered by removing a user defined number of frames per second or combining interlaced frames to accelerate time. The time warp feature is programmable and enables the packet memory array 330 to have the shortest possible latency time delay before rendering or broadcast. The time warp feature may self adjust based on information from the geographic network compensator and user input. This feature is advantageous for live broadcasts that are not synced with time code at a later time.

Yet another feature is the ability of a user to select low latency or high quality such that the user may vary the latency and quality depending on specific needs. For example, a broadcaster may prefer low latency for direct to air web casts and high quality/high latency for recording video that does not need less than five seconds latency. Such a latency setting may be infinitely variable depending on field conditions and user needs.

The MCS device 120 may include an on-board recorder that records the input stream anytime there is a video signal or other data entering up to the MCS device 120. The on-board recorder may be removable solid state drive capable of storing several hours of digital video (DV) or high-definition video (HDV). This footage may be rebroadcast at any time. This feature may allow a user to receive a low latency, low quality video stream initially via a multi-channel stream and then have footage to edit a news story or any content with the low quality. Then, the user may later download the high quality video that was recorded in the MCS device 120, selecting with time code, time of day or other parameters only the high-quality edited clips needed at the time. These selected clips may be streamed to the client slower than real-time but at a higher quality.

Another feature includes a stream quality return that is a confidence return loop capable of showing the latency time, signal bandwidth and a network availability factor (NAF) for the current location. This is useful information that provides an indication if the MCS device 120 have moved into an area of poor coverage. This information may be overlaid on the GPS moving map feature.

Another feature includes a seamless video identifier (SVI) that maintains a constant communication link for video signals to the server even if the camera or other source is disconnected from the MCS device 120 or not turned on. This video signal may be automatic and may be transmitted in the absence of any other video signal. This image may have user defined identification information including GPS location of the MCS device 120.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A device, comprising:
an input for receiving a signal;
a distribution module coupled to the input and operable to divide the signal into a plurality of packets and operable to distribute the packets;
a plurality of transmission channels coupled to the distributor such that the distributor distributes packets amongst the plurality of channels, each channel having a bandwidth; wherein the distribution module is operable to change the distribution to a channel based on the bandwidth.

2. The device of claim 1, wherein the plurality of transmission channels correspond to a plurality of wireless network modems that are operable to communicate with at least one wireless network.

3. The device of claim 2, wherein the plurality of wireless network modems include at least one wireless network modem operable to communicate with a first wireless network and at least one network modem operable to communicate with a second wireless network.

4. The device of claim 2 wherein the at least one wireless network comprises one of a cellular network, a Wi-Fi network, a WiMax network, satellite network, Ethernet network.

5. The device of claim 1 further comprising a structural deck coupled to each of the plurality of transmission channels wherein the deck is suited to reduce interference between the transmission channels.

6. The device of claim 1 further comprising a communication port operable to communicate with a remote control computing device, such that the remote control computing device is operable to change the bandwidth of any of the plurality of transmission channels.

7. The device of claim 1 further comprising a rechargeable battery coupled to the distribution module and coupled to the plurality of transmission channels such that power is provided.

8. The device of claim 1 further comprising a feedback module operable to receive a feedback signal, wherein the feedback is indicative of packets that are not transmitted properly.

9. A method, comprising:
receiving a signal a distribution module;
dividing the signal into a plurality of components;
distributing the components to a plurality of transmission channels;
assessing the bandwidth of at least one of the plurality of transmission channels; and
in response, adjusting the distribution of components to the assessed transmission channel.

10. The method of claim 9, further comprising:
transmitting each component over one or more transmission channels; and
receiving each component at a receiver located remotely with respect to the distribution module.

11. The method of claim 10, further comprising:
reassembling the received components,
identifying at least one transmitted but not received component; and
requesting retransmission of the identified component.

12. The method of claim 9, further comprising:
in response to the assessment, determining that the assessed transmission channel is compromised; and
removing the compromised transmission channel from the plurality of channel available to distribute components.

13. The method of claim 9 further comprising:
Assessing the bandwidth of each of the plurality of transmission channels; and
Adjusting the distribution of the components based upon the assessment of each bandwidth of each of the transmission channels.

14. The method of claim 13 wherein the adjusting further comprises reducing the distribution of components to a transmission channel assessed to have a lower bandwidth and increasing the distribution of components to a transmission channel assessed to have a higher bandwidth.

15. The method of claim 9 wherein distributing the components of a plurality of transmission channels comprises distributing the components to at least six wireless transmission channels.

16. The method of claim 9 wherein the signal comprises an audio signal and a video signal.

17. A system, comprising:
a camera operable to capture a video signal;
a wireless distribution module coupled to the camera and operable to decompose the video signal into a plurality of packets of data suitable for communication via a packet-switched network;
a plurality of packet-switched networks coupled to the wireless distribution module, each operable to transmit at most some of the packets of data over a respective packet-switched network; and
a server computer communicatively coupled to each of the plurality of packet-switched networks and operable to reassemble received packets of data into the video signal.

18. The system of claim 17, further comprising a remote computing device operable to log into the distribution module and control the distribution of packets of data.

19. The system of claim 17, wherein the plurality of packet-switched networks comprises at least one packet-switched network operating according to a first protocol and at least one packet-switched network operating according to a second network protocol.

20. The system of claim 17, further comprising a global positioning module coupled to the server computer and operable to identify the global position of the wireless distribution module.
